(19) United States
(12) Patent Application Publication
(10) Pub. No.: US 2024/0420481 A1
(43) Pub. Date: Dec. 19, 2024

(54) FALSE POSITIVE OBJECT DETECTION BASED ON CANDIDATE OBJECT ILLUMINATION

(71) Applicant: QUALCOMM Incorporated, San Diego, CA (US)

(72) Inventor: David Oskar Peter Forslund, Linkoping (SE)

(21) Appl. No.: 18/336,184

(22) Filed: Jun. 16, 2023

(51) Int. Cl. G06V 20/56; G06V 10/60; G06V 10/77

(52) U.S. Cl. CPC G06V 20/56; G06V 10/60; G06V 10/77

(57) ABSTRACT

This disclosure provides systems, methods, and devices for vehicle driving assistance systems that support image processing. In a first aspect, an image processing method includes receiving, from an image sensor of a camera, a plurality of image frames representative of an area in view of the camera; determining a portion of the plurality of image frames that depict a candidate object located in the area; determining a first indicator of illumination associated with the plurality of image frames; and determining a second indicator that indicates a probability that an image characteristic of the candidate object is consistent with the first indicator. The image characteristic is indicative of an illumination of the candidate object. One or more machine learning models are utilized for the determination steps. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road.

Example embodiments provide systems that determine whether a candidate object detected by an object detection system can be classified as a false positive or an actual object based on an indicator of illumination associated with an image frame depicting the candidate object. The image frame is representative of an area in view of a camera (e.g., image sensor). When the candidate object can be classified as a false positive, the candidate object may be a visual depiction of an actual object. For example, the candidate object may be a reflection of an object on a reflective surface, or an image of an object on a billboard.

The candidate object can be classified as a false positive when an image characteristic indicative of the illumination of the candidate object in the image frame is inconsistent with the indicator of illumination associated with the image frame. For example, in some embodiments, the indicator of illumination includes a position of the sun. In such embodiments, the candidate object can be classified as a false positive if the image characteristic of the depicted candidate object is inconsistent with where the sun is positioned. By determining that a candidate object (e.g., a reflection of a vehicle) is not an actual object (e.g., the vehicle depicted in the reflection), but is rather a false positive, object detection performance of a driving assistance system of a vehicle is improved.

In one aspect of the disclosure, a method for image processing for use in a driving assistance system includes receiving, from an image sensor, a plurality of image frames; determining a candidate object depicted in the plurality of image frames; determining a first indicator that indicates an illumination associated with the plurality of image frames; and determining, using a machine learning model, a second indicator that indicates a probability that an image characteristic indicative of an illumination of the candidate object is consistent with the first indicator.

In an additional aspect of the disclosure, an apparatus includes at least one processor and a memory coupled to the at least one processor. The at least one processor is configured to perform operations including receiving, from an image sensor, a plurality of image frames; determining a candidate object depicted in the plurality of image frames; determining a first indicator that indicates an illumination associated with the plurality of image frames; and determining, using a machine learning model, a second indicator that indicates a probability that an image characteristic indicative of an illumination of the candidate object is consistent with the first indicator.

In an additional aspect of the disclosure, a non-transitory computer-readable medium stores instructions that, when executed by a processor, cause the processor to perform operations. The operations include receiving, from an image sensor, a plurality of image frames; determining a candidate object depicted in the plurality of image frames; determining a first indicator that indicates an illumination associated with the plurality of image frames; and determining, using a machine learning model, a second indicator that indicates a probability that an image characteristic indicative of an illumination of the candidate object is consistent with the first indicator.

In an additional aspect of the disclosure, a vehicle includes a plurality of cameras including a plurality of image sensors, a memory, and a processor in communication with the memory. The processor is configured to perform the operations including receiving, from the plurality of image sensors, a plurality of image frames; determining a candidate object depicted by the plurality of image frames; determining a first indicator that indicates an illumination associated with the plurality of image frames; and determining, using machine learning model, a second indicator that indicates a probability that an image characteristic indicative of an illumination of the candidate object is consistent with the first indicator.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHZ, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A. B. or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating an example apparatus for determining whether a candidate object is a false positive according to one or more aspects of the disclosure.

FIG. 5 is a flow diagram illustrating an example pipeline for determining whether a candidate object is a false positive according to one or more aspects of the disclosure.

FIG. 6 is a flow chart illustrating an example method for determining whether a candidate object is a false positive according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Object detection may result in false positives by incorrectly determining a candidate object exists at a location when the candidate object is incorrectly identified. For example, a picture of a vehicle on a billboard may be recognized as a vehicle on the road, leading to incorrect control of the vehicle to avoid collisions. The present disclosure provides systems, apparatus, methods, and computer-readable media that utilizes information regarding the illumination of an area in which an object is located to eliminate false positives. For example, the sun position may be used to check whether a detected candidate object has a sun reflection at the correct location relative to the sun position. In one implementation, the false positive elimination may be implemented using a trained model (e.g., neural network) that operates using the output of a trained illumination model and the output of the object detection system to attach a classifier to the detected candidate objects.

Stated differently, the present disclosure provides systems, apparatus, methods, and computer-readable media that support determining whether a candidate object represented in an image frame and detected by an object detection system is a false positive or an actual object based on an indicator of illumination associated with the image frame and an image characteristic of the candidate object. The image frame is representative of an area (e.g., outdoor area) in view of a camera. When the candidate object can be classified as a false positive, the candidate object may be a visual depiction of an actual object. For example, the visual depiction may be a reflection of an object on a reflective surface. In another example, the visual depiction may be an image of an object on a billboard. In another example, the visual depiction may include multiple objects represented in the image frame that together form the visual depiction of the actual object.

The candidate object is determined to be a false positive when one or more image characteristics of the candidate object depicted in the image frame are inconsistent with the indicator of illumination associated with the image frame. The indicator represents an illumination of the area in which the candidate object depicted in the image frame is located. In various aspects, the indicator can be determined from contextual information (e.g., time of day, location, weather data, camera direction, etc.) associated with the area in which the candidate object depicted in the image frame is located, a plurality of image frames representative of the area, or portion of the area, in which the candidate object is located, or both. For example, a machine learning model may be trained to output information indicative of an illumination of the portion of the area represented by the image frame based on input including the contextual information and/or the plurality of image frames representing the area or the portion of the area. In one example, the information indicative of the illumination includes a position of the sun. The candidate object can be classified as a false positive if image characteristic of the candidate object (e.g., a reflection depicted on the candidate object's surface), which is indicative of an illumination of the candidate object, is inconsistent with the indicator of illumination of the portion of the area in which the candidate object is located.

As used herein, the term “visual depiction” refers to a visual representation of an object rather than the object itself. For example, a visual depiction may include a reflection of an object, a two-dimensional image (e.g., print, paint, etc.) of an object, a hologram of an object, a three-dimensional model of an object, or a set of objects that together appear to depict an object. The set of objects include, for example, objects at different distances and physical positions that together, from a certain viewing angle, appear to form the visual appearance of the object. For example, a distant tunnel in combination with nearer objects, such as traffic signs, can look similar or exactly like a vehicle from certain viewing angles in some instances. In another example, a visual depiction excludes visuals that fail to represent an object, such as a shadow created by an object being positioned between the sun and the surface on which the shadow is visible, or a general two-dimensional outline of an object.

Particular implementations of the subject matter described in this disclosure may be implemented to realize one or more of the following potential advantages or benefits. In some aspects, the present disclosure provides techniques for image processing that may be particularly beneficial in smart vehicle applications. For example, by determining that a candidate object (e.g., a reflection of a vehicle) is not an actual object (e.g., the vehicle depicted in the reflection), but is rather a false positive, object detection performance of a driving assistance system of a vehicle is improved. The improved object detection can further improve other driving assistance system functions that rely on object detection.

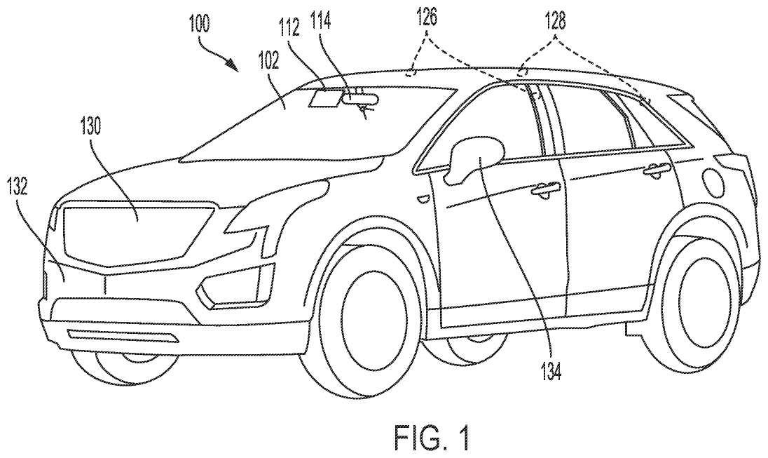

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

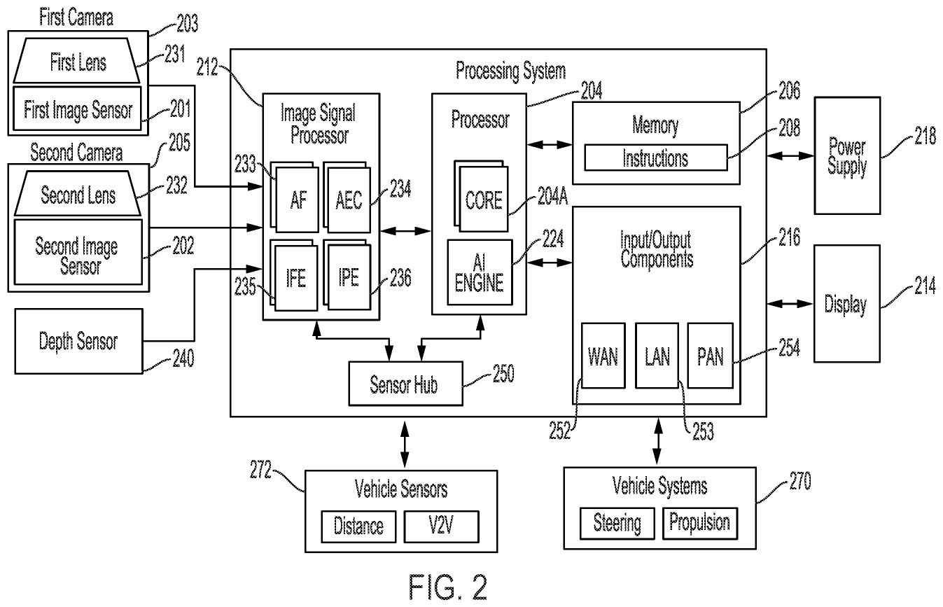

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

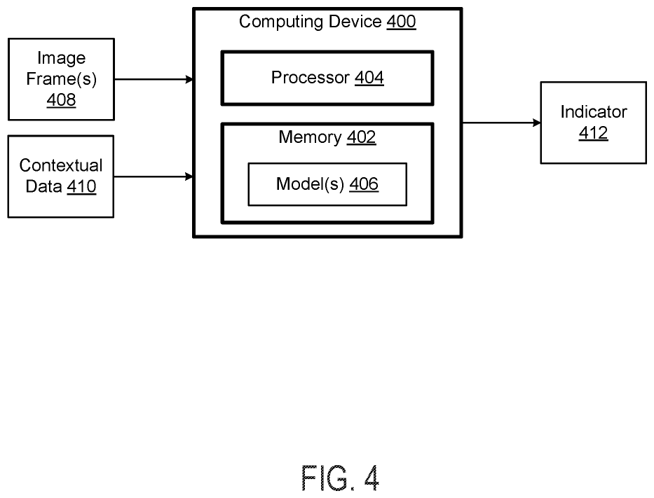

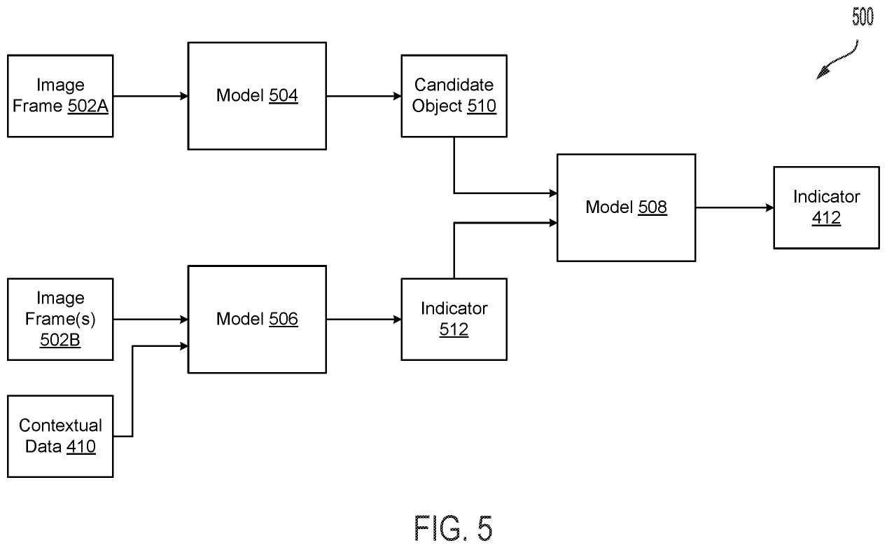

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination). The accuracy of the output of commands to the vehicle systems 270 may be improved according to embodiments of this disclosure by using one or more machine learning models, such as that described in connection with FIGS. 4-5, to determine whether a candidate object represented in an image frame and detected by an object detection system can be classified as a false positive, which can affect the commands sent to the vehicle systems 270.

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

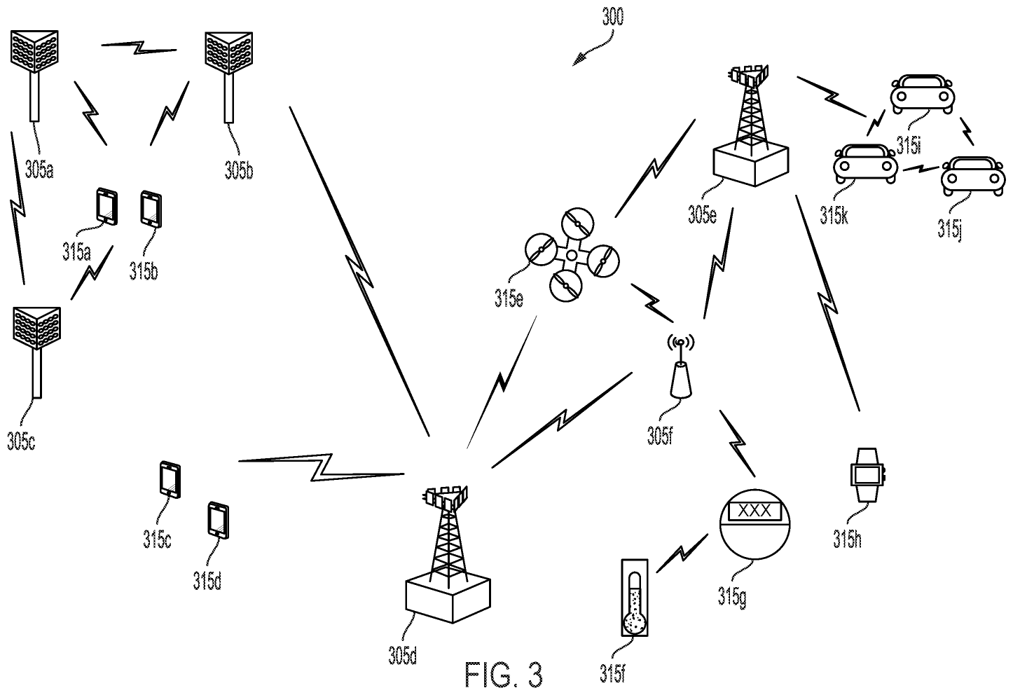

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (COMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports communications with ultra-reliable and redundant links for certain devices. Redundant communication links with UE 315c include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305c.

Aspects of the vehicular systems described with reference to, and shown in, FIG. 1, FIG. 2, and FIG. 3 may include determining whether a candidate object represented in an image frame and detected by an object detection system is a false positive or an actual object based on whether an illumination of the candidate object is consistent with an illumination of an area in which the represented candidate object is located. The image frame is representative of an area in view of a camera (e.g., image sensor of the camera) . . . . In such aspects, the candidate object is determined to be an actual object when an image characteristic of the candidate object depicted in the image frame is consistent with an indicator of illumination associated with the image frame. Conversely, the candidate object is determined to be a false positive when the image characteristic of the candidate object depicted in the image frame is inconsistent with the indicator of illumination associated with the image frame.

FIG. 4 is a block diagram illustrating a computing device 400 for determining whether a candidate object represented in an image frame and detected by an object detection system is a false positive or an actual object. Computing device 400 includes a memory 402 in communication with a processor 404. For example, memory 402 may include, or be included in, memory 206. In another example, processor 404 may include, or be included in, processor 204. Memory 402 stores one or more models 406. One or more image frames 408 are received by computing device 400 and input into the one or more models 406. The one or more image frames 408 are representative of one or more portions of an area (e.g., outdoor area) in view of a camera (e.g., first camera 203 or second camera 205). In some aspects, contextual data 410 may further be received by computing device 400 and input into the one or more models 406. Contextual data 410 includes information indicative of any suitable factor that affects the illumination (e.g., lighting conditions) of the outdoor area in view of the camera. For example, contextual data 410 may include information indicative of a time of day, a pose (e.g., location and orientation) of the camera, the camera's direction of travel, weather conditions (e.g., presence of clouds, rain, sun, etc.), or other suitable information that can reasonably affect the illumination of an outdoor area. Based on the input to the one or more models 406, the one or more models 406 are trained to output an indicator 412 of a probability that an image characteristic of a candidate object detected in an image frame of the one or more image frames 408 is consistent with lighting conditions of the one or more portions of the area represented by the one or more image frames 408. In some aspects, the one or more models 406 are trained such that the indicator 412 indicates a degree that the image characteristic of a candidate object detected in an image frame of the one or more image frames 408 is consistent with lighting conditions of the one or more portions of the area represented by the one or more image frames 408.

The one or more models 406 may be implemented as one or more machine learning models, including supervised learning models, unsupervised learning models, other types of machine learning models, and/or other types of predictive models. For example, the one or more models 406 may be implemented as one or more of a neural network, a transformer model, a decision tree model, a support vector machine, a Bayesian network, a classifier model, a regression model, and the like. Computing device 400 may be implemented by the image processing configuration of FIG. 2 or by one or more of the components illustrated in FIG. 3. While the one or more models 406 are shown stored in memory 402 of computing device 400, in other examples, the one or more models 406 may be stored on a separate computing device (e.g., a server) in communication with computing device 400 over a network.

FIG. 5 is a flow diagram illustrating an example pipeline 500 for generating indicator 412 using the one or more models 406. In the illustrated example, the one or more models 406 are implemented as model 504, model 506, and model 508. In other examples, two or three of models 504, 506, and 508 may be combined. In other examples, model 504, model 506, and model 508 may instead be implemented as different layers of a single model. In some aspects, two of the layers in such other examples may be combined.

As shown in FIG. 5, in pipeline 500, model 504 receives an image frame 502A as input. Image frame 502A is included in the one or more image frames 408. In some aspects, more than one image frame 502A is input into model 504. In such aspects, the two or more image frames 502A may be captured at a same point in time or at different points in time. Image frame 502A is captured by one or more cameras (e.g., first camera 203 or second camera 205) and is representative of an area in view of the image sensor. Model 504 is trained to detect and output a candidate object 510 depicted in the image frame 502A. In various aspects, candidate object 510 includes a position of candidate object 510 in image frame 502A, in the area in which the depicted candidate object is located, or both. In various aspects, candidate object 510 includes a probability of class or existence of candidate object 510. In some aspects, model 504 may output feature embeddings instead of candidate object 510. In other aspects, model 504 may output tensors of neural network weights instead of candidate object 510. When implemented, model 504 can run on image frames captured by a camera using the same time-step as model 506.

Candidate object 510 can be a variety of objects, or visual depictions of objects, that may be located in an outdoor area. For instance, examples of a candidate object 510 include a vehicle, a pedestrian, a hazard for a vehicle (e.g., pole, beam, sign, construction equipment, etc.), or visual depictions of the same.

Model 504 may be implemented as one or more machine learning models, including supervised learning models, unsupervised learning models, other types of machine learning models, and/or other types of predictive models. For example, model 504 may be implemented as one or more of a neural network, a transformer model, a decision tree model, a support vector machine, a Bayesian network, a classifier model, a regression model, and the like. For example, model 504 may be any suitable object detection model in the pertinent art of this disclosure. In some instances, candidate object 510 is an actual object. In other instances, candidate object 510 is a visual depiction that may be mistaken by an object detection system as an actual object.

In some implementations, model 506 receives one or more image frames 502B as input. The one or more image frames 502B are included in the one or more image frames 408. In some aspects, the one or more image frames 502B include the one or more image frames 502A. The one or more image frames 502B are captured by one or more cameras (e.g., first camera 203 or second camera 205) and are representative of the area in view of the image sensor. For example, the one or more image frames 502B may be single image frames captured by a single camera, or the one or more image frames 502B may be image frames captured by multiple different cameras (e.g., a surround-view setup). In these implementations, model 506 is trained to output an indicator 512 of the illumination (e.g., lighting conditions) of the area depicted by the one or more image frames 502B based on the one or more image frames 502B input to model 506. For example, the one or more image frames 502B may be multiple image frames from different time steps over a long duration of time so that model 506 can estimate the illumination robustly over time, since the illumination of the area is typically slow changing.

In other implementations, model 506 alternatively receives contextual data 410 regarding factors that influence the illumination of the area in view of the image sensor, and is trained to output indicator 512 based on the contextual data 410. In other implementations still, model 506 is trained to output indicator 512 based on inputs of both the one or more image frames 502B and contextual data 410.

Model 506 may determine indicator 512 based on image frames captured by any camera of a set of cameras (e.g., cameras disposed on a vehicle). Indicator 512 can then be applied to any camera up a set of cameras. For example, indicator 512 could be determined based on image frames captured by a right-rear camera of a vehicle, a left-rear camera of the vehicle, and a right-side camera of the vehicle. The indicator 512 in this example can be input into model 508 with a candidate object 510 extracted from an image frame captured by a left-front camera of the vehicle.

In some aspects, indicator 512 represents information indicative of a general illumination of the outdoor area. Examples of information indicative of the general illumination include sky color, sun color, sky diffuseness, an outdoor illumination environment map, etc. In other aspects, indicator 512 represents information indicative of a position of the sun, or of a position of the sun relative to a detected candidate object. The position of the sun may further be an example of information indicative of the general illumination in various aspects. Indicator 512 may include latent variables (e.g., weights) associated with the illumination of the outdoor area. In some aspects, indicator 512 is a neural feature embedding of arbitrary size, which is designed for assisting in determining whether features of candidate object 510 are consistent with indicator 512.

In various aspects, model 506, or an additional model in architecture 500, may be trained on weather information (e.g., fog, precipitation, etc.) to output an expected weather condition that can affect the illumination of the outdoor area and of candidate object 510. In such aspects, indicator 512 is determined based on the expected weather condition.

Model 506 may be implemented as one or more machine learning models, including supervised learning models, unsupervised learning models, other types of machine learning models, and/or other types of predictive models. For example, model 506 may be implemented as one or more of a neural network, a transformer model, a decision tree model, a support vector machine, a Bayesian network, a classifier model, a regression model, and the like. Model 506 may be trained, in some aspects, based on training data that includes expected illumination outputs (e.g., expected sun position) and a plurality of image frames from different time steps over an extended period of time. For example, model 506 may be trained using synthetic images with known illumination parameters. In other aspects, model 506 may be trained based on training data that includes expected illumination outputs (e.g., expected sun position) and contextual information associated with each expected illumination output. In other aspects, model 506 is contemplated to be any suitable model, with accompanying inputs, in the pertinent art of this disclosure that predicts information related to how an outdoor area is illuminated.

Model 508 receives candidate object 510 and indicator 512 as input. Though not shown in FIG. 5, in some aspects, an extracted image characteristic of candidate object 510 indicative of an illumination of candidate object 510 is additionally input into model 508. In other aspects, model 508 may be trained to extract the image characteristic from the input candidate object 510. Example image characteristics indicative of the illumination of candidate object 510 include a cast shadow visible on or adjacent to candidate object 510, a sun reflection on a surface of candidate object 510, a reflection of another object on a surface of candidate object 510, the lack of a reflection on a surface of candidate object 510, and an intensity of illumination of candidate object 510. With reference to a vehicle as candidate object 510, examples of cast shadows include a shadow of the vehicle cast adjacent to the vehicle, a shadow of the vehicle's rearview mirror cast onto the vehicle's hood, and a shadow of the vehicle's side mirror cast on the vehicle's front passenger seat.

Based on this input to model 508, model 508 is trained to output indicator 412 that indicates a probability that the image characteristic of the candidate object 510 is consistent with indicator 512. Stated differently, model 508 is trained to determine whether the image characteristic indicative of an illumination of candidate object 510 is consistent or inconsistent with illumination provided by the environment in which candidate object 510 is located. If the image characteristic of candidate object 510 is consistent (e.g., the probability meets a threshold) with indicator 512, then candidate object 510 can be classified as an actual object based on indicator 412. For example, a sun reflection (e.g., image characteristic) visible on a surface of a vehicle (e.g., candidate object 510) may be oriented in a way such that the sun reflection is consistent with where the sun is positioned in the sky. In another example, a shadow cast on a vehicle's hood by the vehicle's rearview mirror may be oriented in a way such that the shadow is consistent with where the sun is positioned in the sky.

If the image characteristic of candidate object 510 is instead inconsistent (e.g., the probability fails to meet the threshold) with indicator 512, then candidate object 510 can be classified as a visual depiction of an object instead of the object itself, e.g., a false positive, based on indicator 412. For instance, if candidate object 510 is not illuminated as expected, then it is likely that candidate object 510 is a visual depiction of an actual object rather than the actual object itself. For example, a sun reflection (e.g., image characteristic) visible in a reflection of a vehicle (e.g., candidate object 510) may be oriented in a way such that the sun reflection is inconsistent with where the sun is positioned in the sky because the vehicle reflection (and reflected sun reflection) is a mirror image of the actual vehicle (and actual sun reflection) being reflected. In another example, a shadow (e.g., image characteristic) of a vehicle (e.g., candidate object 510) cast adjacent the vehicle may be on the wrong side of the vehicle relative to the sun position such that the cast shadow is inconsistent with where the sun is positioned in the sky. In some aspects, indicator 412 indicates a degree that the image characteristic is consistent with indicator 512.

In some aspects, the one or more image frames 502B from which model 506 determines indicator 512 may represent a different view of the area than the view represented by the one or more image frames 502A from which model 504 determines candidate object 510. For example, there may be instances in which the sun is not visible in any of the views represented by the one or more image frames 502A depicting candidate object 510. In such instances, one or more image frames 502B representing a different view in which the sun is visible may be used to determine indicator 512, which is then used to determine indicator 412. Stated differently, model 508 can utilize image frames representing views including a candidate object and image frames representing views absent the candidate object to determine whether the candidate object is illuminated consistently with the illumination present in the area in which the candidate object is located.

In an example usage scenario, a function of a vehicle (e.g., vehicle 100) may be controlled based on indicator 412. For example, the autonomous braking application (AEB) of vehicle 100 can be controlled to stop vehicle 100 when indicator 412 indicates the probability that the image characteristic of the candidate object 510 is consistent with indicator 512 meets a threshold such that candidate object 510 is classified as an actual object and vehicle 100 is on course to collide with the actual object. In another example, the autonomous cruise control (ACC) of vehicle 100 can be controlled to keep vehicle 100 on course when indicator 412 indicates the probability that the image characteristic of the candidate object 510 is consistent with indicator 512 fails to meet a threshold such that candidate object 510 is classified as a visual depiction of an actual object, since vehicle 100 is not in danger of colliding with the stationary visual depiction in this example.

Model 508 may be implemented as one or more machine learning models, including supervised learning models, unsupervised learning models, other types of machine learning models, and/or other types of predictive models. For example, model 508 may be implemented as one or more of a neural network, a transformer model, a decision tree model, a support vector machine, a Bayesian network, a classifier model, a regression model, and the like. Model 508 may be trained based on training data to determine whether candidate object 510 is a false positive or an actual object. For example, one or more training datasets may be used that contain image frames depicting actual objects, image characteristics indicative of an illumination of the actual objects in the image frames, image frames depicting false positives, image characteristics indicative of an illumination of the false positives in the image frames, and illumination information or sun position, or both of outdoor areas in which the actual objects or false positives are located for each image frame. The training data sets may specify one or more expected outputs. For example, the training data sets may specify whether an expected output is a classifier indicating an actual object or a classifier indicating a false positive. Parameters of the model 508 may be updated based on whether the model 508 generates correct outputs when compared to the expected outputs. In particular, the model 508 may receive one or more pieces of input data from the training data sets that are associated with a plurality of expected outputs. The model 508 may generate predicted outputs based on a current configuration of the model 508. The predicted outputs may be compared to the expected outputs and one or more parameter updates may be computed based on differences between the predicted outputs and the expected outputs. In particular, the parameters may include weights (e.g., priorities) for different features and combinations of features (e.g., illumination information, sun position, visual features related to illumination). The parameter updates the model 508 may include updating one or more of the features analyzed and/or the weights assigned to different features or combinations of features (e.g., relative to the current configuration of the model 508).

In various aspects, model 504 and model 508 may be trained jointly while model 506 is trained independently. In such aspects, an output of model 506 based on the training images may be inferred when jointly training models 504 and 508. In other aspects, model 104 may be trained independently from model 508. In such other aspects, model 508 may be trained on inferred output from model 504 and model 506. In aspects in which indicator 512 is a learnt feature embedding, the learnt feature embedding can be learned jointly with training model 508, and in some instances, also with training model 504.

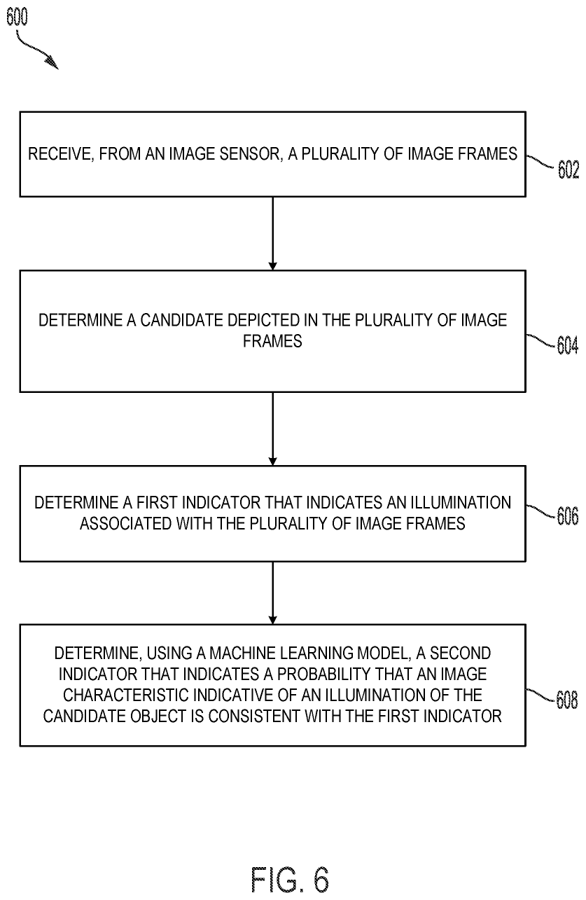

One method of performing image processing according to embodiments described above is shown in FIG. 6. FIG. 6 is a flow chart illustrating an example method for determining whether a candidate object is a false positive or an actual object. A method 600 includes, at block 602, receiving, from an image sensor (e.g., first image sensor 201 or second image sensor 202), a plurality of image frames (e.g., image frames 408).

At block 604, a candidate object (e.g., candidate object 510) depicted by the plurality of image frames is determined. In at least some examples, the candidate object is determined using a machine learning model (e.g., one or more models 406, such as model 504). In some aspects, the candidate object is a reflection of an object that is visible on a reflective surface depicted in the plurality of image frames. In other aspects, the candidate object is a two-dimensional image of an object (e.g., an image on a billboard). In other aspects still, the candidate object includes a plurality of objects depicted in the plurality of image frames that together form the candidate object.

At block 606, a first indicator (e.g., indicator 512) that indicates an illumination associated with the plurality of image frames is determined. In various examples, the first indicator is determined using a machine learning model (e.g., the one or more models 406, such as model 506). In one example, the first indicator includes information indicative of an illumination of an area depicted by the plurality of image frames. In this example, the candidate object depicted in the plurality of image frames is located within the area. Examples of such information include sky color, sun color, sky diffuseness, an outdoor illumination environment map, etc. In another example, the first indicator, additionally or alternatively, includes a position of the sun.

At block 608, a second indicator (e.g., indicator 412) is determined using a machine learning model (e.g., the one or more models 406, such as model 508). The second indicator indicates a probability that an image characteristic indicative of an illumination of the candidate object is consistent with the first indicator. For instance, the candidate object can be classified as a false positive if the image characteristic is inconsistent with the first indicator. In one example, the image characteristic of the candidate object includes: a shadow depicted on a surface of the candidate object, or adjacent the candidate object, in the image frame; or a reflection depicted on the surface of the candidate object in the plurality of image frames; or both the shadow and the reflection.

In various aspects, method 600 further includes determining that the candidate object is a visual depiction of an actual object instead of the actual object based on the probability failing to meet a threshold. Conversely, method 600 may include determining that the candidate object is an actual object based on the probability meeting the threshold. In some aspects, the threshold for determining the candidate object is a visual depiction may be different than the threshold for determining the candidate object is an actual object.

In various aspects, method 600 further includes determining a set of objects depicted in the plurality of image frames. The set of objects excludes the candidate object. For instance, the image characteristic of the candidate object is determined to be inconsistent with the first indicator in these aspects and the candidate object is determined to be a false positive such that it is not included as a detected object.

In various aspects, method 600 further includes controlling a function of a vehicle (e.g., vehicle 100) based on the second indicator. For example, the ACC of vehicle 100 can be controlled to keep vehicle 100 on course based on the second indicator indicating the probability that the image characteristic of the candidate object is consistent with the first indicator fails to meet a threshold since the vehicle is thereby not in danger of colliding with the visual depiction that is the candidate object.

It is noted that one or more blocks (or operations) described with reference to FIG. 5 or 6 may be combined with one or more blocks (or operations) described with reference to another of the figures. For example, one or more blocks (or operations) of FIG. 5 or 6 may be combined with one or more blocks (or operations) of FIGS. 1-3. As another example, one or more blocks associated with FIG. 6 may be combined with one or more blocks associated with FIGS. 4-5. As another example, one or more blocks associated with FIG. 5 may be combined with one or more blocks associated with FIG. 4.

In one or more aspects, techniques for supporting vehicular operations may include additional aspects, such as any single aspect or any combination of aspects described below or in connection with one or more other processes or devices described elsewhere herein. In a first aspect, an apparatus is configured to perform operations including receiving, from an image sensor, a plurality of image frames; determining a candidate object depicted in the plurality of image frames; determining a first indicator that indicates an illumination associated with the plurality of image frames; and determining, using a machine learning model, a second indicator that indicates a probability that an image characteristic indicative of an illumination of the candidate object is consistent with the first indicator. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the image characteristic of the candidate object includes: a shadow depicted on a surface of the candidate object, or adjacent the candidate object, in the plurality of image frames; or a reflection depicted on the surface of the candidate object in the plurality of image frames; or both the shadow and the reflection.

In a third aspect, in combination with one or more of the first aspect or the second aspect, the candidate object is a reflection of an object that is visible on a reflective surface depicted in the plurality of image frames.

In a fourth aspect, in combination with one or more of the first aspect through the third aspect, the candidate object is a two-dimensional image of an object.

In a fifth aspect, in combination with one or more of the first aspect through the fourth aspect, the candidate object comprises a plurality of objects depicted in the plurality of image frames that together form the candidate object.

In a sixth aspect, in combination with one or more of the first aspect through the fifth aspect, the operations the apparatus is configured to perform further include determining that the candidate object is a visual depiction of an object instead of the object based on the probability failing to meet a threshold.

In a seventh aspect, in combination with one or more of the first aspect through the sixth aspect, the first indicator includes a position of the sun.

In an eighth aspect, in combination with one or more of the first aspect through the seventh aspect, wherein the plurality of image frames depict an area including the candidate object, and wherein the first indicator indicates an illumination associated with the area.

In a ninth aspect, in combination with one or more of the first aspect through the eighth aspect, the operations the apparatus is configured to perform further include determining a set of objects depicted in the plurality of image frames. The set of objects excludes the candidate object.

In a tenth aspect, in combination with one or more of the first aspect through the ninth aspect, the operations the apparatus is configured to perform further include controlling a function of a vehicle based on the second indicator.

In an eleventh aspect, in combination with one or more of the first aspect through the tenth aspect, a vehicle includes a plurality of cameras including a plurality of image sensors. The vehicle is configured to perform the operations including receiving, from the plurality of image sensors, a plurality of image frames; determining a candidate object depicted by the plurality of image frames; determining a first indicator that indicates an illumination associated with the plurality of image frames; and determining, using a machine learning model, a second indicator that indicates a probability that an image characteristic indicative of an illumination of the candidate object is consistent with the first indicator.

In a twelfth aspect, in combination with the eleventh aspect, the first indicator is determined based on the plurality of image frames.

In a thirteenth aspect, in combination with the eleventh aspect, the first indicator is determined based on a second plurality of image frames. The candidate object is absent from the second plurality of image frames.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for image processing for use in a driving assistance system, comprising:
receiving, from an image sensor, a plurality of image frames;
determining a candidate object depicted in the plurality of image frames;
determining a first indicator that indicates an illumination associated with the plurality of image frames; and
determining, using a machine learning model, a second indicator that indicates a probability that an image characteristic indicative of an illumination of the candidate object is consistent with the first indicator.

2. The method of claim 1, wherein the image characteristic of the candidate object includes:
a shadow depicted on a surface of the candidate object, or adjacent the candidate object, in the plurality of image frames; or
a reflection depicted on the surface of the candidate object in the plurality of image frames; or
both the shadow and the reflection.

3. The method of claim 1, wherein the candidate object is a reflection of an object that is visible on a reflective surface depicted in the plurality of image frames.

4. The method of claim 1, wherein the candidate object is a two-dimensional image of an object.

5. The method of claim 1, wherein the candidate object comprises a plurality of objects depicted in the plurality of image frames that together form the candidate object.

6. The method of claim 1, further comprising determining that the candidate object is a visual depiction of an object instead of the object based on the probability failing to meet a threshold.

7. The method of claim 1, wherein the first indicator includes a position of the sun.

8. The method of claim 1, wherein the plurality of image frames depict an area including the candidate object, and wherein the first indicator indicates an illumination associated with the area.

9. The method of claim 1, further comprising determining a set of objects depicted in the plurality of image frames, wherein the set of objects excludes the candidate object.

10. The method of claim 1, further comprising controlling a function of a vehicle based on the second indicator.

11. An apparatus, comprising:
a memory; and
at least one processor coupled to the memory, the at least one processor configured to perform operations including:
receiving, from an image sensor, a plurality of image frames;
determining a candidate object depicted in the plurality of image frames;
determining a first indicator that indicates an illumination associated with the plurality of image frames; and
determining, using a machine learning model, a second indicator that indicates a probability that an image characteristic indicative of an illumination of the candidate object is consistent with the first indicator.

12. The apparatus of claim 11, wherein the image characteristic of the candidate object includes:
a shadow depicted on a surface of the candidate object, or adjacent the candidate object, in the plurality of image frames; or
a reflection depicted on the surface of the candidate object in the plurality of image frames; or
both the shadow and the reflection.

13. The apparatus of claim 11, wherein the candidate object is a reflection of an object that is visible on a reflective surface depicted in the plurality of image frames.

14. The apparatus of claim 11, wherein the candidate object is a two-dimensional image of an object.

15. The apparatus of claim 11, wherein the candidate object comprises a plurality of objects depicted in the plurality of image frames that together form the candidate object.

16. The apparatus of claim 11, further comprising determining that the candidate object is a visual depiction of an object instead of the object based on the probability failing to meet a threshold.

17. The apparatus of claim 11, wherein the first indicator includes a position of the sun.

18. The apparatus of claim 11, wherein the plurality of image frames depict an area including the candidate object, and wherein the first indicator indicates an illumination associated with the area.

19. The apparatus of claim 11, wherein the operations further include determining a set of objects depicted in the plurality of image frames, wherein the set of objects excludes the candidate object.

20. The apparatus of claim 11, wherein the operations further include controlling a function of a vehicle based on the second indicator.

21. A non-transitory computer-readable medium storing instructions that, when executed by a processor, cause the processor to perform operations comprising:
receiving, from an image sensor, a plurality of image frames;
determining a candidate object depicted in the plurality of image frames;
determining a first indicator that indicates an illumination associated with the plurality of image frames; and
determining, using a machine learning model, a second indicator that indicates a probability that an image characteristic indicative of an illumination of the candidate object is consistent with the first indicator.

22. The non-transitory, computer-readable medium of claim 21, wherein the image characteristic of the candidate object includes:
a shadow depicted on a surface of the candidate object, or adjacent the candidate object, in the plurality of image frames; or
a reflection depicted on the surface of the candidate object in the plurality of image frames; or
both the shadow and the reflection.

23. The non-transitory, computer-readable medium of claim 21, wherein the candidate object is a two-dimensional image of an object, the candidate object is a reflection of an object that is visible on a reflective surface depicted in the plurality of image frames, or the candidate object comprises a plurality of objects depicted in the plurality of image frames that together form the candidate object.

24. The non-transitory, computer-readable medium of claim 21, wherein the first indicator includes a position of the sun.

25. The non-transitory, computer-readable medium of claim 21, wherein the operations further include controlling a function of a vehicle based on the second indicator.

26. A vehicle, comprising:
a plurality of cameras including a plurality of image sensors;
a memory; and
a processor in communication with the memory, the processor configured to perform operations including:
receiving, from the plurality of image sensors, a plurality of image frames;
determining a candidate object depicted by the plurality of image frames;
determining a first indicator that indicates an illumination associated with the plurality of image frames; and
determining, using a machine learning model, a second indicator that indicates a probability that an image characteristic indicative of an illumination of the candidate object is consistent with the first indicator.

27. The vehicle of claim 26, wherein the image characteristic of the candidate object includes:
a shadow depicted on a surface of the candidate object, or adjacent the candidate object, in the plurality of image frames; or
a reflection depicted on the surface of the candidate object in the plurality of image frames; or
both the shadow and the reflection.

28. The vehicle of claim 26,
wherein the candidate object is a two-dimensional image of an object, the candidate object is a reflection of an object that is visible on a reflective surface depicted in the plurality of image frames, or the candidate object comprises a plurality of objects depicted in the plurality of image frames that together form the candidate object.

29. The vehicle of claim 26, wherein the first indicator is determined based on the plurality of image frames.

30. The vehicle of claim 26, wherein the first indicator is determined based on a second plurality of image frames, wherein the candidate object is absent from the second plurality of image frames.
